(19) United States
(12) Patent Application Publication
(10) Pub. No.: US 2022/0382006 A1
(43) Pub. Date: Dec. 1, 2022

(54) OUTDOOR/INDOOR OPTICALCABLES WITH LOW-FRICTION SKIN LAYER

(71) Applicant: OFS Fitel, LLC, Norcross, GA (US)

(72) Inventors: Harold P Debban, Snellville, GA (US); Annabelle J Scarpaci, Douglasville, GA (US); Peter A Weimann, Atlanta, GA (US)

(73) Assignee: OFS Fitel, LLC, Norcross, GA (US)

(21) Appl. No.: 17/769,910

(22) PCT Filed: Oct. 9, 2020
(86) PCT No.: PCT/US20/54893

§ 371 Date: Apr. 18, 2022

Related U.S. Application Data
(60) Provisional application No. 62/923,778, filed on Oct. 21, 2019.

(51) Int. Cl. G02B 6/44

(52) U.S. Cl. CPC G02B 6/443

(57) ABSTRACT

An optical fiber cable having reduced surface friction may include a low-friction, fire retardant cable jacket structure. The cable jacket structure may include a thicker, highly fire-retardant cable jacket, and a thinner, low-friction skin layer formed over the cable jacket.

### CROSS-REFERENCE TO RELATED APPLICATION

The benefit of U.S. Provisional Patent Application No. 62/923,778, filed Oct. 21, 2019, entitled “OUTDOOR/INDOOR OPTICAL CABLES WITH REDUCED SURFACE FRICTION THROUGH USE OF SKIN LAYER,” is hereby claimed and the disclosure thereof incorporated herein in its entirety by this reference.

### BACKGROUND

An optical fiber cable comprises two or more optical fibers enclosed within a jacket. Optical fiber cables in a class sometimes referred to as “outdoor/indoor” have characteristics that include flexibility to facilitate routing through tight spaces, such as through conduit, and flame retardance for safety. Outdoor/indoor cables are commonly routed between outdoor and indoor spaces, often for hundreds of meters. Flame retardance generally means resistance to flame spread and smoke emission. To achieve high flame retardance, a cable jacket may be made of a mineral-filled low-smoke zero-halogen (LSZH) material. These types of highly flame retardant materials generally use very soft base resins in order to allow good dispersion of the mineral fillers. As a result, cable jackets made of such materials have high surface friction, which can make it difficult to install long lengths in conduit.

### SUMMARY

Embodiments of the invention relate to optical fiber cables having reduced surface friction. In an exemplary embodiment, an optical fiber cable includes a cable jacket structure comprising a fire-retardant cable jacket with a low-friction skin layer over the jacket. The skin layer is thinner than the cable jacket. Two or more optical fibers are contained within the interior of the cable jacket.

In another exemplary embodiment, an optical fiber cable includes a cable jacket, a low-friction skin layer over the cable jacket, and two or more optical fibers within the interior of the cable jacket. The cable jacket may have a thickness between 1.0 and 3.0 millimeters (mm), an abrasion resistance greater than 200 cubic millimeters (mm³), and a Limiting Oxygen Index (LOI) between 38 and 70 percent. The skin layer may have a thickness between 0.2 and 0.5 mm, an abrasion resistance between 12 and 200 mm³, and an LOI between 16 and 40 percent.

Other cables, methods, features, and advantages will be or become apparent to one of skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of a cable jacket structure, in accordance with exemplary embodiments of the invention.

FIG. 2 is a cross-sectional view of an optical fiber cable having the cable jacket structure of FIG. 1, in accordance with exemplary embodiments of the invention.

FIG. 3 is a table showing an example of parameters of the cable jacket structure of FIG. 1, in accordance with exemplary embodiments of the invention.

FIG. 4 is another table showing another example of parameters of the cable jacket structure of FIG. 1, in accordance with exemplary embodiments of the invention.

FIG. 5 is top plan view of a rollable ribbon, in accordance with exemplary embodiments of the invention.

FIG. 6 is a sectional view of the rollable ribbon of FIG. 5.

FIG. 7 is a perspective view of an optical fiber cable, in accordance with exemplary embodiments of the invention.

FIG. 8 is a sectional view of the optical fiber cable of FIG. 7.

FIG. 9 is a sectional view of another optical fiber cable, in accordance with exemplary embodiments of the invention.

### DETAILED DESCRIPTION

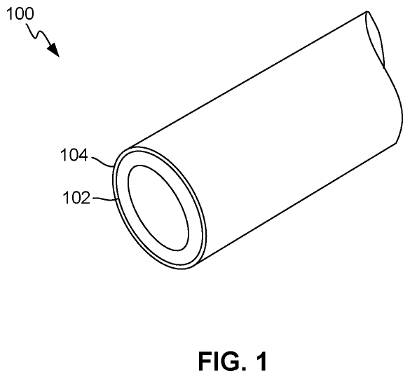

As illustrated in FIG. 1 (not to scale), in an illustrative or exemplary embodiment of the invention, a cable jacket structure 100 comprises a generally tubular cable jacket 102 and a skin layer 104 formed over the cable jacket 102, i.e., on the exterior surface of the cable jacket 102. For example, the skin layer 104 may be extruded over the cable jacket 102 or may be a coating on the cable jacket 102. As described in further detail below, the skin layer 104 may be substantially thinner than the cable jacket 102 and made of a low-friction material compared with the material of which the cable jacket 102 is made. The cable jacket 102 is made of a highly flame retardant material. The low-friction skin layer 104 may be less flame retardant than the cable jacket 102.

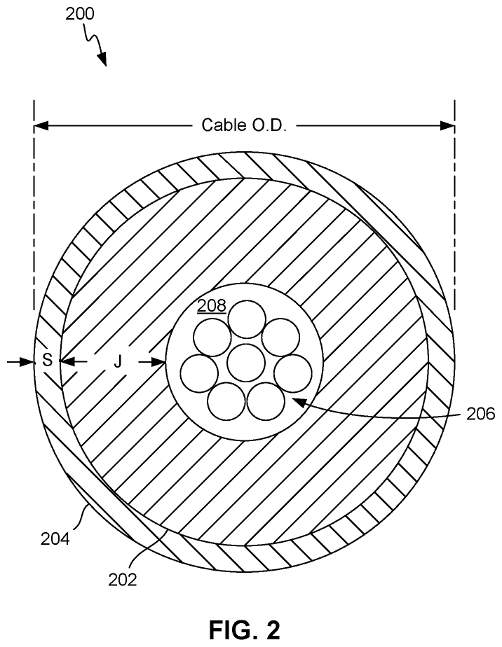

As illustrated in FIG. 2, an optical fiber cable 200 may have a structure similar to the above-described cable jacket structure 100 (FIG. 1). Optical fiber cable 200 may comprise a cable jacket 202, a skin layer 204 formed over the cable jacket 202, and a plurality of optical fibers 206 contained within an interior 208 of the cable jacket 202. The thickness (J) of the cable jacket 202 may be, for example, between 1.0 and 3.0 millimeters (mm), while the thickness (S) of the skin layer 204 may be, for example, between 0.2 and 0.5 mm. The outside diameter (O.D.) of the optical fiber cable 200 (which is also the O.D. of the skin layer 204) may be, for example, between 5 and 35 mm.

Abrasion resistance may serve as proxy for the low-friction property of the skin layer 204. The skin layer 204 may have a substantially higher abrasion resistance than the cable jacket 202. For purposes of the present disclosure, abrasion resistance may be measured using the well-known method standardized as ISO 4649-A. The ISO 4649-A method yields a value for abrasion resistance in units of cubic millimeters (mm³). The skin layer 204 may have an abrasion resistance of, for example, between 12 and 200 mm³ measured using the ISO 4649-A method. The thinner skin layer 204 may be somewhat fire retardant, but need not be as highly fire retardant as the cable jacket 202. Examples of suitable materials of which the skin layer 204 may be made include halogenated materials such as polytetrafluoroethylene (PTFE), polyether ether ketone (PEEK), and LSZH (Low Smoke Zero Halogen) materials such as PPS, polyimide, Nylon, Acetal, Polyester and thermoplastic polyurethane (TPU)-based flame retardant thermoplastics.

Fire retardance may be defined in terms of Limiting Oxygen Index (LOI), which is the minimum concentration of oxygen, expressed as a percentage, that will support combustion of a polymer. The cable jacket 202 may be made of a polymer having an LOI of, for example, between 38 and 70 percent. The cable jacket 202 may have a substantially greater fire retardance than the skin layer 204. As the cable jacket 202 is substantially thicker than the skin layer 204, the cable jacket 202 may provide the majority of the fire retardance of the cable 200. In contrast with the above-referenced cable jacket LOI range of between 38 and 70 percent, the skin layer 204 may have an LOI in the range of, for example, between 16 and 40 percent. Examples of suitable materials of which the cable jacket 202 may be made include LSZH mineral-filled flame retardant materials such as polyethylene, polypropylene and ethylene vinyl acetate (EVA), or halogenated flame retardant materials such as polyvinyl chloride (PVC) or polyvinylidene fluoride (PVDF).

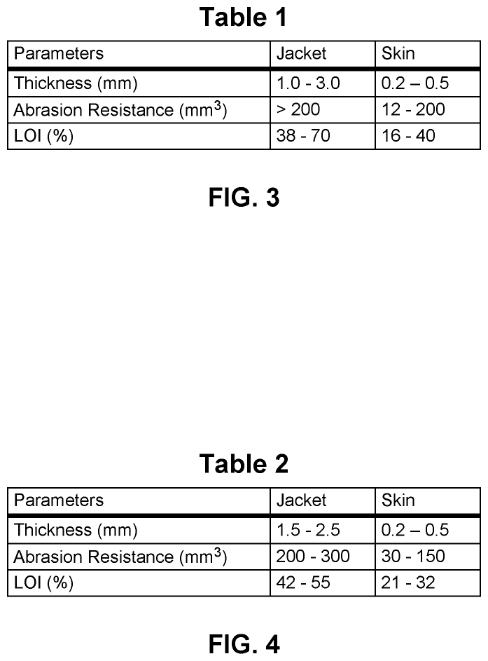

As illustrated in FIG. 3, exemplary embodiments of the cable 200 (FIG. 2) may be characterized by the combinations of the above-described parameters of thickness, abrasion resistance, and LOI set forth in Table 1. For example, the jacket 202 may have a thickness between 1.0 and 3.0 mm, an abrasion resistance greater than 200 mm³, and an LOI between 38 and 70 percent, while the skin layer 204 may have a thickness between 0.2 and 0.5 mm, an abrasion resistance between 12 and 200 mm³, and an LOI between 16 and 40 percent.

As illustrated in FIG. 4, exemplary embodiments of the cable 200 (FIG. 2) may be further characterized by the combinations of the above-described parameters of thickness, abrasion resistance, and LOI set forth in Table 2. For example, the cable jacket 202 may have a thickness between 1.5 and 2.5 mm, an abrasion resistance between 200 and 300 mm³, and an LOI between 42 and 55 percent, while the skin layer 204 may have a thickness between 0.2 and 0.5 mm, an abrasion resistance between 30 and 150 mm³, and an LOI between 21 and 32 percent.

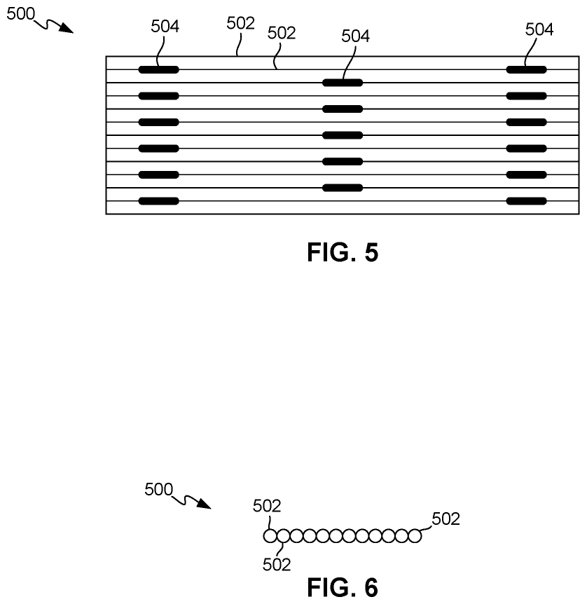

As illustrated in FIG. 5, the above-described optical fibers (e.g., the plurality of optical fibers 206 in FIG. 2) may be in the form of one or more so-called “rollable” optical fiber ribbons 500, an exemplary one of which is shown in FIGS. 5-6. Rollable optical fiber ribbon 500 comprises a plurality of optical fibers 502 joined to each other intermittently along their lengths with patches of adhesive, commonly referred to as a matrix material 504. As well understood by one of ordinary skill in the art, although rollable optical fiber ribbon 500 has the generally flat or ribbon shape shown in FIGS. 5-6 when laid flat (i.e., in a plane) with its optical fibers 502 arrayed parallel to each other, the intermittent (rather than continuous) distribution of matrix material 504 leaves the optical fibers 502 sufficiently free or unconstrained that they can roll into or otherwise assume a compact bundle or roughly cylindrical shape, such as the shape shown in cross section in FIG. 2.

The pattern of matrix material 504 shown in FIGS. 5-6 or other characteristics of the rollable optical fiber ribbon 500 described herein are intended only as examples, and one of ordinary skill in the art will recognize that other types of rollable optical fiber ribbon are suitable. A common characteristic possessed by all such rollable optical fiber ribbons is that the intermittent (rather than continuous) distribution of matrix material 504 provides the ribbon with sufficient flexibility to enable it to be rolled into the above-described bundle shape or cylindrical shape and yet return to a ribbon shape when laid flat. The term “rollable” is understood by one of ordinary skill in the art in the context of optical fiber ribbons to specifically refer to a ribbon having this characteristic, provided by the intermittent rather than continuous distribution of matrix material 504. A “rollable” ribbon may be contrasted with what is commonly referred to in the art as a “flat” or “encapsulated” ribbon, in which matrix material is distributed continuously along the length of the fibers. In a flat ribbon, the fibers may be fully encapsulated within the matrix material. The rigidity of encapsulated optical fiber ribbons presents challenges to achieving high fiber packing density in cables. The development of rollable ribbons has led to higher fiber packing density in cables.

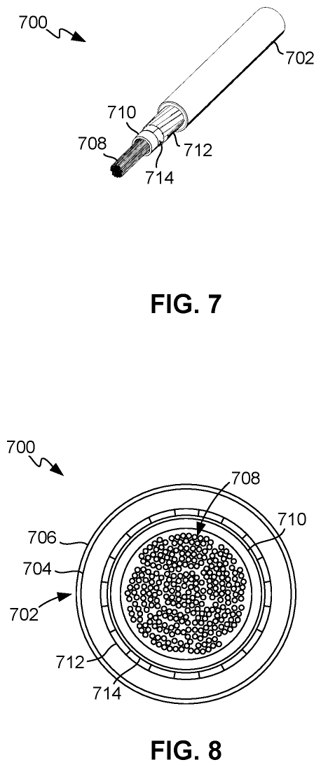

As illustrated in FIGS. 7-8, in another exemplary embodiment an optical fiber cable 700 includes a cable jacket structure 702, which may be similar to the cable jacket structure 100 described above with regard to FIG. 1. Accordingly, the jacket structure 702 may comprise a cable jacket 704 (FIG. 8) and a skin 706 over the cable jacket 704. The cable jacket structure 702 may be characterized by the physical parameters described above with regard to FIGS. 2-4.

Within the interior of the cable jacket 704 is a bundle 708 of two or more rollable optical fiber ribbons (not individually indicated in FIG. 7) contained within a central tube 710. The cable 700 may also include a plurality of reinforcing members 712 between jacket 704 and central tube 710. Reinforcing members 712 may comprise, for example, helically arranged fiberglass yarn strands, fiberglass rods or aramid yarn. A layer of water-blocking tape 714, which could be flame retardant as well, may also be included between central tube 710 and reinforcing members 712. Another layer (not shown) of water-blocking tape, which could be flame retardant as well, may also be included between the rollable optical fiber ribbons 708 and the central tube 710.

Although a central tube configuration is shown as an example in FIGS. 7-8, a dual-layer jacket in accordance with the present disclosure could be included in a cable having any other configuration, including loose tube design, slotted core design and tight buffer design for example.

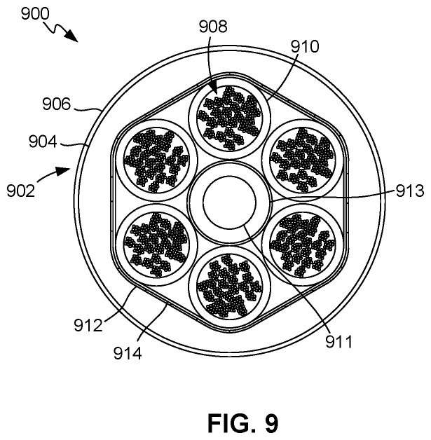

As illustrated in FIG. 9, an example of a loose tube optical fiber cable 900 includes a cable jacket structure 902, which may be similar to the cable jacket structure 100 described above with regard to FIG. 1. Accordingly, the jacket structure 902 may comprise a cable jacket 904 and a skin 906 over the cable jacket 904. The cable jacket structure 902 may be characterized by the physical parameters described above with regard to FIGS. 2-4.

Within the interior of the cable jacket 904 are bundles 908 of two or more rollable optical fiber ribbons (not individually indicated in FIG. 9) loosely contained within a plurality of tubes 910. The cable 900 may also include a semi-rigid reinforcing member 911, such as a fiberglass or metal rod, contained within a central tube 913. The cable 900 may include reinforcing members 912, such as, for example, helically arranged fiberglass yarn strands, fiberglass rods or aramid yarn, between cable jacket 904 and the plurality of tubes 910. A layer of water-blocking tape 914, which may be flame retardant, may be included between the plurality of tubes 910 and reinforcing members 912 and around the central tube 913.

In the manner described above, a fire retardant optical fiber cable may be provided that can readily be installed in tight spaces over substantial distances. A highly fire retardant jacket may provide the majority of the cable's fire retardance. A low-friction skin, which need not provide as much fire retardance as the jacket, facilitates ease of installation, such as through long conduit lengths.

One or more illustrative or exemplary embodiments of the invention have been described above. However, it is to be understood that the invention is defined by the appended claims and is not limited to the specific embodiments described.

What is claimed is:

1. An optical fiber cable, comprising:
a cable jacket made of a fire retardant material;
a low-friction skin layer over the cable jacket, the skin layer having a thickness less than a thickness of the cable jacket; and
a plurality of optical fibers within an interior of the cable jacket.

2. The optical fiber cable of claim 1, wherein the skin layer has an abrasion resistance between 12 and 200 cubic millimeters (mm³).

3. The optical fiber cable of claim 1, wherein the cable jacket has a limiting oxygen index (LOI) between 38 and 70 percent.

4. The optical fiber cable of claim 1, wherein:
the thickness of the cable jacket is between 1.0 and 3.0 millimeters (mm); and
the thickness of the skin layer is between 0.2 and 0.5 mm.

5. The optical fiber cable of claim 4, wherein:
the skin layer has an abrasion resistance between 12 and 200 mm³;
the cable jacket has an abrasion resistance greater than 200 mm³; and
the cable jacket has a limiting oxygen index (LOI) between 38 and 70 percent.

6. The optical fiber cable of claim 1, wherein the plurality of optical fibers form a rollable ribbon comprising an array of the optical fibers joined parallel to one another by a matrix material intermittently distributed along adjacent optical fibers in the array.

7. The optical fiber cable of claim 6, wherein an outside diameter of the optical fiber cable is between 5 and 35 mm.

8. The optical fiber cable of claim 7, further comprising:
a central tube within the interior of the cable jacket containing the plurality of optical fibers; and
a plurality of reinforcing members between the jacket and the central tube.

9. The optical fiber cable of claim 8, further comprising water-blocking tape between the central tube and the reinforcing members.

10. The optical fiber cable of claim 1, wherein:
the thickness of the cable jacket is between 1.5 and 2.5 millimeters (mm);
the thickness of the skin layer is between 0.2 and 0.5 mm;
the skin layer has an abrasion resistance of between 30 and 150 mm³; and
the cable jacket has a limiting oxygen index (LOI) between 42 and 55 percent.

11. The optical fiber cable of claim 10, wherein the cable jacket has an abrasion resistance of between than 200 and 300 mm³.

12. The optical fiber cable of claim 10, wherein the plurality of optical fibers form a rollable ribbon comprising an array of the optical fibers joined parallel to one another by a matrix material intermittently distributed along adjacent optical fibers in the array.

13. The optical fiber cable of claim 12, wherein an outside diameter of the optical fiber cable is between 5 and 35 mm.

14. The optical fiber cable of claim 13, further comprising:
a central tube within the interior of the cable jacket containing the plurality of optical fibers; and
a plurality of reinforcing members between the jacket and the central tube.

15. The optical fiber cable of claim 14, further comprising water-blocking tape between the central tube and the reinforcing members.

16. An optical fiber cable, comprising:
a cable jacket having a thickness between 1.0 and 3.0 millimeters (mm), an abrasion resistance greater than 200 mm³, and a Limiting Oxygen Index (LOI) between 38 and 70 percent;
a skin layer over the cable jacket, the skin layer having a thickness between 0.2 and 0.5 mm, an abrasion resistance between 12 and 200 mm³, and an LOI between 16 and 40 percent; and
a plurality of optical fibers within an interior of the cable jacket.

17. The optical fiber cable of claim 16, wherein the plurality of optical fibers form a rollable ribbon comprising an array of the optical fibers joined parallel to one another by a matrix material intermittently distributed along adjacent optical fibers in the array.

18. The optical fiber cable of claim 17, wherein an outside diameter of the optical fiber cable is between 5 and 35 mm.

19. The optical fiber cable of claim 18, further comprising:
a central tube within the interior of the cable jacket containing the plurality of optical fibers; and
a plurality of reinforcing members between the jacket and the central tube.

20. The optical fiber cable of claim 19, further comprising water-blocking tape between the central tube and the reinforcing members.
